(19) United States
(12) Patent Application Publication
(10) Pub. No.: US 2019/0052748 A1
(43) Pub. Date: Feb. 14, 2019

(54) METHOD AND APPARATUS FOR ALTERING A MOBILE COMMUNICATION DEVICE OPERATION

(71) Applicant: THOMSON Licensing, Issy-les-Moulineaux (FR)

(72) Inventor: John Sidney STEWART, INDIANAPOLIS, IN (US)

(21) Appl. No.: 16/065,731

(22) PCT Filed: Dec. 22, 2015
(86) PCT No.: PCT/US2015/067337

§ 371 Date: Jun. 22, 2018

(51) Int. Cl. H04M 1/725; H04M 1/60

(52) U.S. Cl. CPC H04M 1/72577; H04M 1/6075; H04M 1/72569

(57) ABSTRACT

A method and an apparatus for altering operation of a mobile communication device while the user of the mobile communication device is operating or driving a vehicle are provided. The method (400) and apparatus (800, 101, 201, 302, 500, 600, 704) of the present disclosure receive data from a sensor (102, 303, 646), the data related to movement performed by a user, determine if the user is driving a vehicle by determining at least one user movement associated with driving a vehicle based on the data, and alter operation of the mobile communication device (101, 201, 500, 600, 704, 800) if it is determined that the user is driving the vehicle. A computer-readable storage medium and a non-transitory computer-readable program product are also provided for altering operation of a mobile communication device.

### TECHNICAL FIELD

The present disclosure generally relates to mobile devices and mobile communication systems, and more particularly, to a method and apparatus for altering a mobile communication device operation by a user while the user is operating or driving a vehicle.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

One of the problems in current society is the use of a mobile device (e.g., a cell phone, tablet, etc.) while driving. Using a cell phone while driving, whether to talk or to text, is a major distraction that causes car accidents. This is particularly critical for drivers of public transportation vehicles, for drivers of delivery vehicles and for teenage drivers. Dialing and holding a phone while steering can be an immediate physical hazard, but the actual conversations always distract the driver's attention. Distraction is broadly classified into two categories 1) physical distraction (i.e., visual and mechanical), and 2) cognitive distraction.

When using a hand-held mobile phone, drivers must take away one hand from the steering wheel to hold and operate the phone (i.e., mechanical distraction). The driver must also take their eyes off the road, at least momentarily, to pick up and put down the phone and to dial numbers (i.e., visual distraction). While using a hand-held phone, the driver continues to simultaneously operate the vehicle (e.g., steer, change gear, use indicators, etc.) with only one hand. Although the physical distraction is far greater with hand-held phones, there is still some physical activity with hands-free systems. Even though hands-free systems eliminate the need to hold a phone during a call, the driver must still divert their eyes from the road to locate the phone and (usually) press at least one button.

When mental (i.e., cognitive) tasks are concurrently performed, the performance of both tasks is often worse than if they were performed separately, because attention has to be divided, or switched, between the tasks, and the tasks must compete for the same cognitive resources. When a driver is using a hand-held or hands-free mobile phone while driving, he or she must devote part of their attention to operate the phone and maintain the telephone conversation, and part of their attention to operating the vehicle and responding to the constantly changing road and traffic conditions. The demands of the phone conversation must compete with the demands of driving the vehicle safely.

The practice of using a mobile device while driving has been outlawed or restricted in many areas due to the number of accidents resulting from the distraction caused by the use of the device. One way to reduce this unsafe practice is to have the mobile device detect when the mobile device is being used by a driver and disable itself. There are several potential methods for a mobile device to detect if it is being used by a driver. For example, a mobile device could detect the speed at which it is moving. If it is moving faster than walking speed, it could determine that it is in a moving vehicle. Unfortunately, this method does not distinguish between the driver of a vehicle and its passengers.

Therefore, a need exists for efficient techniques for altering a mobile communication device operation by a user while the user is operating or driving a vehicle. The present disclosure provides such a technique.

### SUMMARY

A method and apparatus for altering operation of a mobile communication device while the user is operating or driving a vehicle are provided.

According to one aspect of the present disclosure, a method of altering operation of a mobile communication device is provided, including receiving data from a sensor, the data related to movement performed by a user, determining if the user is driving a vehicle by determining at least one user movement associated with driving a vehicle based on the data, and altering operation of the mobile communication device if it is determined that the user is driving the vehicle.

According to one aspect of the present disclosure, an apparatus for altering operation of a mobile communication device, the apparatus including a processor in communication with at least one input/output interface, and at least one memory in communication with the processor, the processor being configured to receive data from a sensor, the data related to movement performed by a user, determine if the user is driving a vehicle by determining at least one user movement associated with driving a vehicle based on the data, and alter operation of the mobile communication device if it is determined that the user is driving the vehicle.

### BRIEF DESCRIPTION OF THE DRAWINGS

These, and other aspects, features and advantages of the present disclosure will be described or become apparent from the following description of the embodiments, which is to be read in connection with the accompanying drawings.

In the drawings, wherein like reference numerals denote similar elements throughout the views:

FIG. 1 illustrates a block diagram of an exemplary system for altering a mobile communication device operation by a user while the user is operating or driving a vehicle in accordance with the present disclosure;

FIG. 2 illustrates a block diagram of an exemplary mobile communication device in accordance with the present disclosure;

FIG. 3 illustrates a block diagram of an exemplary wearable device in accordance with an embodiment of the present disclosure;

FIG. 4 illustrates a flowchart of an exemplary method for altering a mobile communication device operation by a user while the user is operating or driving a vehicle in accordance with an embodiment of the present disclosure;

FIG. 5 illustrates an exemplary wearable device in accordance with another embodiment of the present disclosure;

FIG. 6 illustrates a block diagram of an exemplary wearable device in accordance with an embodiment of the present disclosure; and

FIG. 7 illustrates an exemplary system for altering a mobile communication device operation by a user while the user is operating or driving a vehicle in accordance with another embodiment of the present disclosure.

FIG. 8 illustrates a block diagram of a computing environment within which aspects of the present disclosure may be implemented and executed.

It should be understood that the drawing(s) is for purposes of illustrating the concepts of the disclosure and is not necessarily the only possible configuration for illustrating the disclosure.

### DESCRIPTION OF EMBODIMENTS

It should be understood that the elements shown in the figures may be implemented in various forms of hardware, software or combinations thereof. These elements may be implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative system components and/or circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

A method and an apparatus for altering a mobile communication device operation by a user while the user is operating or driving a vehicle are provided. The present disclosure relates to the detection of driver related motion or movement in a vehicle as a way to prevent some or all activities related to a mobile communication device, e.g., smart phone operation. The method and apparatus of the present disclosure build on the concept that the smart phone operation may be restricted based on the speed of movement of a vehicle, e.g., an automobile. A known problem with this approach is that the approach may restrict passengers as well as drivers. To further improve the approach, an additional determination may be made based on basic characteristics of the driving performed by the driver of the vehicle and not a passenger. One such characteristic is steering a car. A driver will move his arms and hands in a circular arc motion (e.g., with a radius of about 6-10 inches) on a regular basis. This movement is not typically done during other normal activities. Thus, a wearable device, such as a smart watch or smart band that has an inertial motion detection capability, can be used to detect this unique motion, and provide an indication of a driver. As a result, the operation of the smart phone, or other mobile communication device, by the driver may be altered (e.g., restricted to hands free calling, no texting, full disabling, imposed hibernation or power saving mode, etc.). In various embodiments of the present disclosure, this detection mechanism may be combined with a motion sensing mechanism, as will be described in greater detail below.

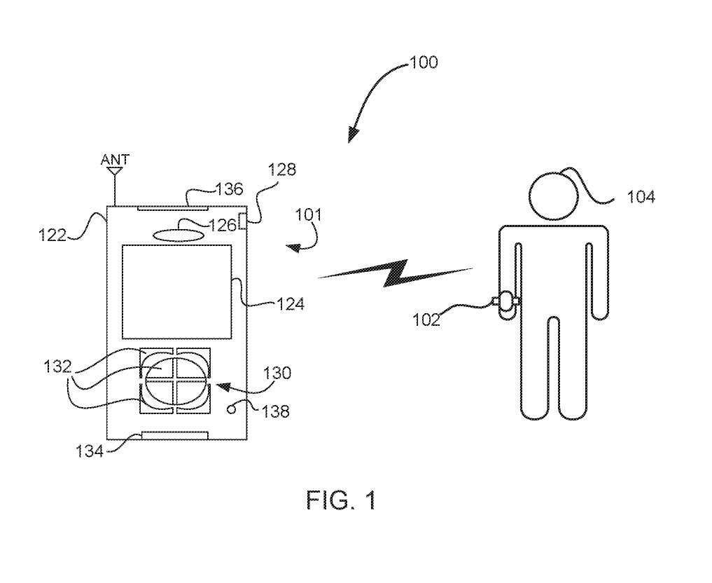

Referring to FIG. 1, an exemplary system 100 in accordance with the present disclosure is illustrated. The system includes a mobile communication device 101 and a sensing device 102 configured to be worn on a user 104, i.e., a wearable device. The mobile communication device 101 may communicate to a mobile device of another user or a server via a communication network. The device 101 may be connected to the communications network, e.g., the Internet, cellular network, etc., by any known means, for example, a hardwired or wireless connection, such as dial-up, hardwired, cable, Digital Subscriber Line (DSL), satellite, cellular, Personal Communications Service (PCS), wireless transmission (e.g., 802.11a/b/g, etc.), etc. It is to be appreciated that the network may be any network known in the art including a telephone network (e.g., a plain old telephone service (POTS) network), a mobile phone network (e.g., cellular, PCS, Global System for Mobile Communications (GSM), etc.), a computer network, a switch data packet network, etc. In one embodiment, the network may be a local area network (LAN), wide area network (WAN), the Internet or any known network that couples a plurality of computers and digital devices to enable various modes of communication via network messages. Furthermore, the server may communicate using the various known protocols such as Transmission Control Protocol/ Internet Protocol (TCP/IP), File Transfer Protocol (FTP), Hypertext Transfer Protocol (HTTP), etc. and secure protocols such as Internet Protocol Security Protocol (IPSec), Point-to-Point Tunneling Protocol (PPTP), Secure Sockets Layer (SSL) Protocol, etc.

The mobile communication device 101 may include various electrical components, which will be described in detail below, disposed in a generally rectangular housing 122. A display module 124 may be provided for displaying video and image media content, such as movies, animations, etc., and a speaker 126 may be provided configured to produce audio, e.g., music or a soundtrack associated with a video. An audio port 128 may be configured to receive a plug or connector from a headphone, stereo system, etc., to stream the audio to the connected device. It is to be appreciated that when an external device is connected to the audio port 128, the speaker 126 may be disabled. Input module 130 may include a plurality of buttons 132 for inputting data and navigating through a plurality of menus. A touch screen overlaid upon the display module 124 may also be coupled to the input module for facilitating user input. The mobile device 101 may further include a storage module 134 for storing a plurality of content and/or a list of contacts.

A transmission module 136 may be provided for transmitting/receiving data and/or content to another device, e.g., a personal computer, a personal digital assistant (PDA), a server residing on the Internet, etc. Optionally, the mobile communication device 101 may include a microphone 138 for acquiring audio from the user of the device to input data.

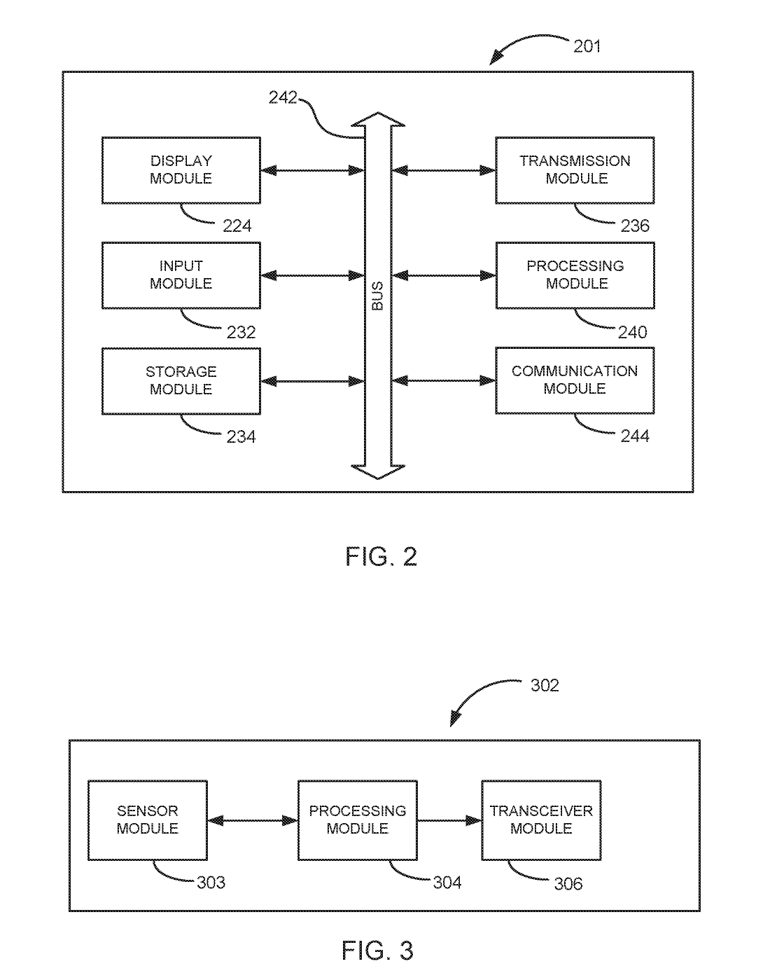

Referring to FIG. 2, the various components of an exemplary mobile communication device 201 will now be described. It is to be appreciated that, in some embodiments, mobile communication device 201 may be similar to mobile communication device 101. Mobile communication device 201 may contain a processing module 240, e.g., a microprocessor, a digital signal processor (DSP), etc. The processing module 240 may use computer software instructions that have been programmed into the module and conventional computer processing power to interact and organize the traffic flow between the various other modules. It is to be understood that the present disclosure may be implemented in various forms of hardware, software, firmware, special purpose processors, or a combination thereof. A system bus 242 may couple the various components shown in FIG. 2 and may be any of several types of bus structures including a memory bus or memory controller, a peripheral bus, and a local bus using any of a variety of bus architectures. The mobile communication device 201 may also include an operating system and micro instruction code preferably residing in read only memory (ROM) (not shown). The various processes and functions described herein may either be part of the micro instruction code or part of an application program (or a combination thereof) which may be executed via the operating system. Exemplary operating systems include, but are not limited to, SymbianOS, Windows Mobile, Windows CE, Windows Phone, Palm OS, Linux, Blackberry OS, Binary Runtime Environment for Wireless (BREW), webOS, Android, iOS, Firefox OS, Sailfish OS, Tizen, Ubuntu Touch OS, etc., which have been developed for mobile computing applications and can handle both data computing and communication applications, e.g., voice communications.

In one embodiment, the processing module 240 may further include, in addition to a microprocessor, a digital signal processor (DSP) for decoding stored audio, video and photo files to be played on the mobile communication device 201. As is known in the art, the DSP may include several known decompression algorithms for decompressing stored media content, e.g., an MP3 file. The mobile communication device 201 of the present disclosure may support various file types including but not limited to Microsoft Windows Media Video files (.wmv), Microsoft Photo Story files (.asf), Microsoft Windows Media Audio files (.wma), MP3 audio files (.mp3), JPEG image files (.jpg, .jpeg, .jpe, .jfif), MPEG movie files (.mpeg, .mpg, .mpe, .m1v, .mp2v .mpeg2), Microsoft Recorded TV Show files (.dvr-ms), Microsoft Windows Video files (.avi and .wmv), realmedia files (.rm) and Microsoft Windows Audio files (.wav).

The mobile communication device 201 may also contain a display module 224 for displaying digital information such as video files, image files, text files, etc. It is to be appreciated that display module 224 may interface to a display, such as display 124 that is in any current form in the art, including, but not limited to, Liquid Crystal Displays (LCD), Light emitting diode displays (LED), Active Matrix Organic Light Emitting Diodes (AMOLED), or any other type of display currently existing or existing in the future. The display module 224 may also include an audio output device, e.g., a speaker 126, audio port 128, etc., allowing the user to also hear audio output from the device 201, e.g., audio associated with a video, a MP3 file, etc.

The mobile communication device 201 of the present disclosure may include a user input module 232 to either receive user instructions via text input by the way of buttons 132, a standard keyboard interface coupled to the device, or a character recognition capture device which translates user text input into alphanumeric characters. In one embodiment, the character recognition device may be a touch screen which overlays the display module 224 and text may be entered via a pen-like stylus. In another embodiment, microphone 138 may be further coupled to the input module 232 for capturing any audio information spoken by the user and the input module may further include an analog-to-digital (A/D) converter for converting the spoken audio information into a digital format. Furthermore, the input module 232 may include a voice recognition processor that translates the digital human voice into alpha numeric characters for user input. The user may utilize the user input module 232 to enter various data, for example, to enter payment information, to initiate communication with a remote server, to flag desired content to be downloaded, to request an initial selection of media content to be downloaded, etc.

In one embodiment, the storage module 234 may include internal storage memory, e.g., random access memory (RAM), or removable memory such as magnetic storage memory; optical storage memory; solid-state storage memory, e.g., a CompactFlash card, a Memory Stick, SmartMedia card, MultiMediaCard (MMC), SD (Secure Digital) memory; or any other memory storage that exists currently or will exist in the future.

In one embodiment, the transmission module 236 may enable the mobile communication device 201 to transmit or transfer information to other computing devices and to receive information from other computing devices, e.g., digital media files, encryption/decryption keys, etc. The transmission module 236 may perform its functionality by hardwired and/or wireless connectivity. The hardwire connection may include, but is not limited to, hard wire cabling e.g., parallel or serial cables, USB cable, Firewire (1394 connectivity) cables, and the appropriate port. The wireless connection operates under any of the various known wireless protocols including but not limited to Bluetooth™ interconnectivity, infrared connectivity, radio transmission connectivity including computer digital signal broadcasting and reception commonly referred to as Wi-Fi or 802.11.X (where x denotes the type of transmission), satellite transmission or any other type of communication protocols or systems currently existing or to be developed for wirelessly transmitting data. The transmission module 236 may be configured to compress and encode the encrypted information for transmission using any known wireless communication technology. In one embodiment, antenna ANT (as shown in FIG. 1) may be coupled to the transmission module 236 for extending the wireless transmission range of the mobile communication device 201.

In one embodiment, the mobile communication device 201, 101 may be embodied as a mobile phone including the modules and architecture illustrated in FIG. 2 and FIG. 1, in accordance with the present disclosure. In this embodiment, a microphone (e.g., 138) may be further coupled to a communication module 244 for encoding a user's speech to be transmitted via antenna ANT using Code Division Multiple Access (CDMA), PCS, GSM, 4G LTE or any other known wireless communication technology. The user may enter phone numbers to be dialed via the touch screen, or alternatively, as is known in the mobile phone art, the device 101,201 may include a full QWERTY keyboard as an input module to enter text information. In addition to producing audio from audio or multimedia content, speaker 116 may be coupled to the antenna ANT and a decoder for receiving and decoding voice communication from another mobile phone.

It is to be appreciated that the communication module 244 may include a single integrated circuit chip to perform data transfer and voice communications or a single module including a separate data transfer chip, e.g., a WiFi transceiver, and a separate voice communication chip, e.g., a CDMA chip. In one embodiment, the communication module may operate on the wireless GPRS (General Packet Radio Service) data protocol, a 3G protocol such as Wideband Code Division Multiple Access (W-CDMA), CDMA2000 and Time Division-Synchronous Code Division Multiple Access (TD-SCDMA) or a 4G Long-Term Evolution (LTE) protocol. Both the GPRS and 3G/4G protocols have the ability to carry both voice and data over the same service.

It is to be appreciated that the device 201 described above is an exemplary device and may include all or a portion of the modules described above. Furthermore, it is to be appreciated that existing mobile devices, e.g., mobile or smart phones, digital media playback device, may be used in accordance with the method and apparatus of the present disclosure, as will be described in greater detail below. Examples of mobile communication devices include, but are not limited to, cellular telephones such as the iPhone™ from Apple™, and the Blackberry™ from Research in Motion™, various Android™ phones licensed by Google™, etc.

Referring to FIG. 3, an exemplary sensing device 302 is illustrated. The sensing device 302 may include at least one sensor module 303 for sensing movement of a user, at least one processor 304 for receiving sensing signals from the sensor module 303 and a transceiver module 306 for interfacing with a mobile communication device 101, 201. It is to be appreciated that the sensing device 302 may be configured to be worn by a user, or may not be worn by a user, and may take many forms such as a generally planar, flexible pad, a glove or a wrist watch. It is also to be appreciated that in some embodiments sensing device 302 may be similar to sensing device 102 (shown in FIG. 1).

The sensor module 303 may include at least one motion sensor to detect motion and/or gestures of a user. In one embodiment, the sensor module 303 may be an inertial measurement unit (IMU) that measures and reports a body's specific force, angular rate, and, optionally, the magnetic field surrounding the body, using at least one of a accelerometer, gyroscope and magnetometer, or any combination thereof. The inertial measurement unit may determine movement of a user by detecting the current rate of acceleration, for example, of a user's hand, using one or more accelerometers, and detects changes in rotational attributes such as pitch, roll and yaw using one or more gyroscopes. Optionally, a magnetometer may be provided to assist in calibration against orientation drift. In one embodiment, the inertial measurement unit may be a nine-axis IMU including a three-axis accelerometer, a three-axis gyroscope and a three-axis magnetometer. In one embodiment, the sensor may be a motion sensing device based on a video camera and able to interpret the movements of a user, e.g., Microsoft™ Kinect™.

In another embodiment, sensor module 303 may include a GPS sensor for detecting a user's position (when the user is wearing sensing device 302) at a given point in time. Furthermore, sensor module 303 may be configured such that by measuring a user's position (via a GPS sensor included in sensor module 303) at various time intervals (for example, once every second, or any other suitable time interval) sensor module 303 can determine a user's current velocity relative to the ground. For example, sensor module 303 may determine that a user A is located at a position X at time T1, and then, after a predetermined time has elapsed, e.g., one or several seconds, sensor module 303 may determine that user A is located at a position Y at a time T2. Sensor module 303 can then determine the user A's velocity relative to the ground by determining user A's displacement (i.e., the distance between position X and position Y) and dividing user A's displacement by the time it took user A to go from position X to position Y (i.e., T2 minus T1). It is to be appreciated that in an alternative embodiment, sensor module 303 may be only configured to sense a user A's position at different points in time and to send the information to processing module 304, where processing module 304 may determine the user A's velocity over a given time intervals as described above.

In a further embodiment, the sensor module 303 may include an electromyography (EMG) sensor that measures electrical potentials generated by the activity of muscle cells. An EMG-based sensing module may be placed on a user according to detailed knowledge of the human physiology, where specific muscle activity may be measured and used to infer movements. For example, an EMG-based sensing module may be employed to determine if a user is gripping a steering wheel of a vehicle.

In one embodiment, the transceiver module 306 may enable the sensing device 302 to communicate wirelessly or by wired means through communications channels such as Wifi, Bluetooth, infrared, cellular communications, satellite communications, cabling, etc., to the mobile communication device 101, 201.

In one embodiment, the sensing device 302 may be configured as a glove, where the sensor module 303, processing module 304 and transceiver module 306 may be disposed in or on the glove. In this embodiment, the sensor module 303 may include magnetic and inertial tracking devices to determine hand position, movement and rotation of the hands and finger bending of a user. In this embodiment, a driving characteristic may be determined if sensor module 303 senses that the user is moving their hand in a radial movement while driving or bending their fingers to grasp a steering wheel of a vehicle. It is to be appreciated that sensor module 303 may be configured such that sensor module 303 may simultaneously sense different types of information about a user. For example, sensor module 303 may concurrently determine a user's velocity, a user's radial hand movement, and the finger bending motion of a user. In this way, sensor module 303 may determine multiple types of information relating to user A (as described above) and may transmit the information to processing module 304 to determine if a user A is currently driving or operating a vehicle.

In one embodiment of the present disclosure, the sensor module 303 may collect the data, and processing module 304 may make a determination of a user's movement and/or velocity, in order to ascertain if the user is driving a vehicle. Once the determination is made that the user is driving a vehicle, a flag or instruction may be generated. The flag or instruction may then be sent by transceiver module 306 to the user's mobile communication device (e.g., 101, 201). Upon reception of the flag or instruction, the user's mobile communication device (e.g., 101, 201) may be configured to alter its operation. The flag or instruction may be interpreted by a software function executed on the mobile communication device. The function may also be implemented in hardware or firmware. The flag or instruction may, for example, receive a value of ‘1’ to indicate that the user is driving the vehicle and a ‘0’ to indicate that the user is not driving the vehicle. In one embodiment, the flag or instruction may be generated and/or sent at regular intervals. In one embodiment, the flag or instruction may identify at least one functionality that is to be disabled by the mobile communication device if the user is driving a vehicle (e.g., 101, 201). For example, the flag or instruction may receive the value of “0001” for disabling phone calls, the value “0010” for disabling texting, the value “0100” for disabling internet access and the value “1000” for disabling games. For example, the flag or instruction may receive the value of “1111” for disabling phone call, text, internet access and games at the same time and the value of “0000” for not disabling any functionality. it is to be understood that many other flags or instructions may be defined within the scope of the present disclosure.

In another embodiment of the present disclosure, sensor module 303 may collect the data and may not perform any determination of a user's movement and/or velocity. The data may then be sent by transceiver module 306 to the user's mobile communication device (e.g., 101, 201) or a second device, for processing and determination of a user's movement and/or velocity, in order to ascertain if the user is driving a vehicle. If a second device received the sensor data and performs the determination that the user is driving a vehicle, the second device may generate and send the flag or instruction to the mobile communication device (e.g., 101, 201). If the mobile communication device performs the determination that the user is driving a vehicle, then the flag or instruction may or not be generated in the same fashion in order to alter the operation of the mobile communication device, since the determination is made within the device.

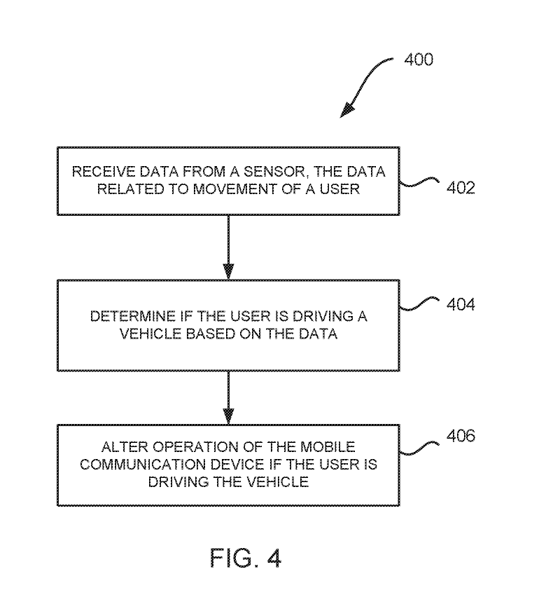

FIG. 4 illustrates a flowchart 400 of an exemplary method of altering operation of a mobile communication device according to the present disclosure. The method includes, at step 402, receiving data from a sensor (e.g., 102, 303, 646), the data related to movement performed by a user. Next, at step 404, the method includes determining if the user is driving a vehicle by determining at least one user movement associated with driving a vehicle based on the data. Finally, at step 406, the method includes altering operation of the mobile communication device (e.g., 101, 201, 500, 600, 704) if it is determined that the user is driving the vehicle. According to the present disclosure, determining at least one user movement may be performed by correlating the data (i.e., sensor data) against reference data representing known movements by a user, or equivalently, measuring a distance between two signals, one being the sensor data and the other one being the reference data for a particular movement of the user. The distance may be measured using an Euclidean distance or other types of distance measures, e.g., Hamming distance, Bhattacharya distance, etc. The distance may be compared against a distance threshold to identify whether the data represents the particular user movement.

According to one embodiment of the method, the at least one user movement is turning a steering wheel.

According to one embodiment of the method, turning the steering wheel is determined by sensing movement of a part of the user's body in a radial motion.

According to one embodiment of the method, the at least one user movement is gripping a steering wheel.

According to one embodiment of the method, the at least one user movement is shifting a gear of the vehicle.

According to one embodiment of the method, the at least one user movement is breaking or accelerating a vehicle by moving a pedal, or a lever. For the case of a pedal operated by a foot, in one embodiment, the sensor may be attached to at least one leg. In another embodiment, the sensor may be on or inside at least one shoe. In yet another embodiment, the sensor may be on or inside the user's clothing, e.g., at least one glove, pant leg, sleeve, shoe, etc.

According to one embodiment of the method, the data includes a user position and the determining step further includes determining a velocity of the user relative to the ground based on the data, and determining if the user is driving the vehicle is further based on the velocity.

According to one embodiment of the method, the method is performed by a sensing device (e.g., 302, 600) including a sensor (e.g., 303, 646).

According to one embodiment of the method, the sensing device (e.g., 302, 600) is worn by the user (e.g., 102, 500). For example, the sensing device may be a smart watch (e.g., 500) or smart band. The smart band may be on at least one arm or leg. The sensing device may be on or inside the clothing of the user.

According to one embodiment of the method, the sensor (e.g., 303, 646) and the mobile communication device (e.g., 101, 201, 500, 600, 704) are disposed in a single device (e.g., 500, 600).

According to one embodiment of the method, the method is performed by the mobile communication device (e.g., 101, 201, 500, 600, 704). In this embodiment, the mobile communication device may make the determination of at least one user movement associated with the user driving a vehicle based on the sensor data, and determine if the user is driving the vehicle. In one embodiment, the determination step may be performed by a software application running on the mobile communication device. In one embodiment, the determination step may be performed by hardware in the mobile communication device or connected to the mobile communication device implementing the functionality.

According to one embodiment of the method, the mobile communication device (e.g., 101, 201, 600, 704) is an integral component of the vehicle.

According to one embodiment of the method, the altering step 406 further includes disabling at least one functionality of the mobile communication device (e.g., 101, 201, 500, 600, 704).

According to one embodiment of the method, the at least one functionality is making or receiving a phone call.

According to one embodiment of the method, the at least one functionality is texting.

According to one embodiment of the method, the altering step 406 further includes maintaining at least one functionality necessary for emergency operation of the mobile communication device (e.g., 101, 201, 500, 600, 704).

According to one embodiment of the method, the method further includes reinstating the at least one functionality of the mobile communication device (e.g., 101, 201, 500, 600, 704) if it is determined that the at least one user movement has not been performed by the user for a predetermined period of time. This embodiment is indicative of a user stopping the car.

According to one embodiment of the method, the altering step 406 further includes generating a flag or instruction to alter operation of the mobile communication device (e.g., 101, 201, 500, 600, 704).

According to one embodiment of the method, the altering step 406 further includes ending a flag or instruction to alter operation of the mobile communication device (e.g., 101, 201, 500, 600, 704).

According to one embodiment of the method, the altering step 406 further includes executing the flag or instruction to alter operation of the mobile communication device (e.g., 101, 201, 500, 600, 704).

It is to be understood that the method according to the present disclosure may be aided by other methods of detecting whether a user is driving a vehicle. In one embodiment, sensors in the driver's seat may detect if a person is sitting on the driver's seat. In one embodiment, sensors on the pedals of a vehicle may detect if the pedals are being pressed or released. In one embodiment, the car speedometer may indicate that the car is in movement. In one embodiment, the car engine may indicate that the car is turned on. In one embodiment, a video camera may indicate that the user is on the driver's seat.

A method for altering a mobile communication device operation by a user while the user is operating or driving a vehicle in accordance with the present disclosure will now be described in relation to FIGS. 1, 2, 3, and 4.

Initially, in step 402, data is received from a sensor 303. It is to be understood that the sensor previously collected data related to a user movement.

In step 404, a sensing device 302, 102 determines at least one movement by the user of the vehicle in order to ascertain if the user is driving a vehicle. The sensing device 302, 102 includes sensor module 303, which may be an inertial motion detection sensor. In one embodiment, the sensor module 303 sends a detected motion to the processing module 304 of the sensing device 302, 102, where the processing module determines if the detected motion is a hand motion associated with moving a steering wheel, i.e., a circular hand motion. In one embodiment, the circular hand motion may be a movement in an arc of approximately 6-10 inch radius, however it is to be appreciated that any arc length may be used as desired in accordance with the present disclosure. If the processing module 304 determines the detected motion is associated with a driving characteristic, the processing module 304 sends an indication, flag, or instruction to the transceiver module 306, which transmits the indication, flag or instruction to the transmission module 236 of the mobile communication device 201, 101.

It is to be understood that, in order for the sensing device to send the indication that the user is driving a vehicle, an interface is established between the sensing device 302, 102 and mobile communication device 201, 101. In one embodiment, the transceiver module 306 of sensing device 302, 102 may communicate to the transmission module 236 of the mobile communication device 201, 101 via Bluetooth™ technology, Wi-Fi™, etc. The processing module 240 of the mobile communications device 201, 101 then receives the indication, flag or instruction of the driving characteristic for further processing.

In other embodiments, the sensing device 302, 102 may send the detected motion (without determining if the motion is associated with a driving characteristic) to the mobile communication device 201, 101, where the processing module 240 of the mobile communications device 201, 101 determines if the motion is associated with a driving characteristic. The mobile communication device (e.g., 101, 201) receives the sensor data in step 402, determines if the user is driving a vehicle in step 404 and alters the operation of the mobile communication device in step 406, if it is determined that the user is driving the vehicle.

It is to be appreciated that sensor 303 or sensing device 302, 102 may also be configured to sense other movements of the driver, e.g., a gear shifting movement, to determine a driving characteristic. Furthermore, movements do not have to be restricted to hand/arm. Sensor 303 may also be configured to sense foot/leg movement on the pedals of a vehicle.

In step 406, the processing module 240 may alter the operation of the mobile communication device 201, 101 if it is determined that the user is driving the vehicle, regardless of whether the processing module 240 made the determination or received the determination from the sensing device 302, 102. In certain embodiments, a secondary indication such as the velocity of the driver/user relative to the ground may be employed to increase the detection probability. For example, the sensing device 302, 102 may determine a velocity of the user wearing the sensing device 302, 102 relative to the ground, as described above. If the speed of the user is above a predetermined value, it may be determined that the user is in a vehicle and not, for example, walking, running, jogging, etc. In another embodiment, the sensing device 302, 102 does not make a determination of velocity and sends the sensor 303 data to the mobile communication device 101, 201 for a determination of velocity. In certain embodiments, the indication of the driving characteristic and the indication of the user's velocity over the predetermined value may both be required before altering operations of the mobile communication device 201, 101.

Furthermore, it is to be appreciated that in certain embodiments multiple detected movements may be used concurrently to increase the accuracy of the determination of whether a user is driving a vehicle or not. For example, in step 404, sensor module 303 may be disposed in a glove, as described above, and simultaneously senses that a user's fingers are in a gripping position and that a user's hand is moving in a circular or radial motion. The processing module 304 may then determine based on a first user movement (e.g., the gripping motion) and a second user movement (e.g., the circular or radial motion) that a user is driving, in step 406. Alternatively, as described above, processing module 304 may send the detected user movements via transceiver module 306 and transmission module 236 to processing module 240 in mobile communication device 201, 101, where processing module 240 may be configured to determine based on the first and second user movements that a user is driving a vehicle. Although above, the gripping and circular motions of a user may be used to determine if a user is driving a vehicle, it is to be appreciated that any user movements detected by sensing device 302, 102 may be combined to determine if a user is driving a vehicle in accordance with the present disclosure. For example, in some embodiments, gear shifting movements and/or foot/leg movements are combined to determine if user is driving a vehicle. In some embodiments, the sensor may be attached to at least one leg, or at least one foot of a user. In one embodiment, the sensor may be disposed in or on the user's clothing, e.g., at least one glove, pant leg, sleeve, shoe, etc. Furthermore, it is to be appreciated that any number of user movements may be combined to determine if a user is driving a vehicle, for example, three or more movements may be combined. Additionally, as stated above, the speed of the user relative to the ground (measured by sensing device 302, 102, as described above) may be combined with multiple measured user movements to determine if a user is driving a vehicle.

Operations of the mobile communication device to be altered/blocked may include texting, phone usage, internet usage (e.g., searches, social networks, e-mail, etc.), video watching, game playing, etc. In one embodiment, downloading content may not be interrupted/blocked if already started. In one embodiment, background processing that does not involve the user participation may not be interrupted. In one embodiment, emergency operation of the mobile communication device in critical situations, 911 and emergency calls/messages like Emergency Alert System (EAS) (national alert system in US), Amber Alerts, weather alerts, traffic alerts, etc., may not be interrupted. Since 911 may also be sent via text, certain texting features may not be disabled completely in certain embodiments.

It is to be appreciated that, in one embodiment, if sensing device 302, 102 does not detect the movements indicative of a driving characteristic, then operation of the mobile communication device 201, 101 may be reinstated after a predetermined period of time. This implies a driver stopping the vehicle to make a phone call. In one embodiment, a predetermined period of time needs to elapse after there is no further detection of the driving characteristic. In another embodiment, after the operation of the mobile communication device 201, 101 is altered, the altered operations may only resume after being enabled by the user, for example, by touching a button, touching a portion of a touchscreen, entering a password, etc.

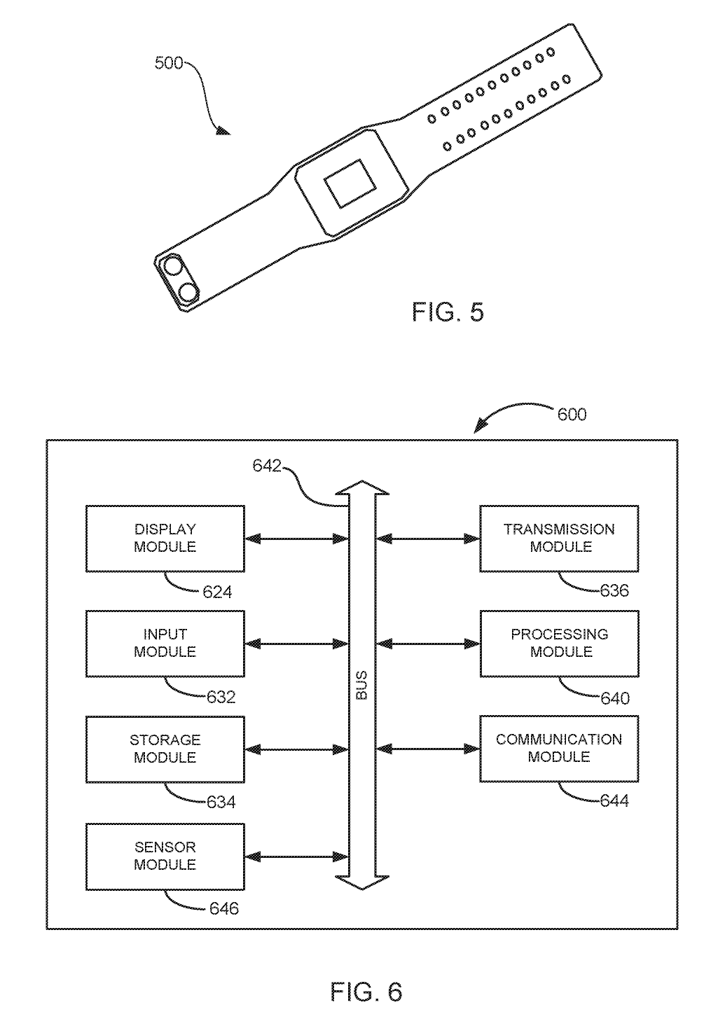

In another embodiment, the components of the mobile communication device and sensing device are combined into a single wearable device, for example, a smart watch or band 500 as illustrated in FIG. 5. Referring to FIG. 6, the various components of an exemplary wearable device 600 are shown. It is to be appreciated that the wearable device 600 may include similar components to those described above in relation to the mobile communication device 201. For example, wearable device 600 may include a display module 624, an input module 632, a storage module 634, a transmission module 636, a processing module 640 and a communication module 644 all coupled together via an appropriate bus 642. The details of the various components will not be described again for sake of briefness and conciseness. Furthermore, wearable device 600 may include a sensor module 646, which may be coupled to bus 642. In this manner, the sensor module 646 may communicate to the processing module 640 to send signals indicating a sensed motion, e.g., a circular motion, and/or the velocity of a user relative to the ground at a given point in time, where the processing module 640 may then alter certain operation of the wearable device 600 based on one or more of the sensed motions of a user and/or the velocity of a user relative to the ground at a given point in time.

In further embodiments of the present disclosure, the driving characteristic may be determined by a sensor for a seat of the vehicle (e.g. detecting the driver seat being occupied as opposed to the passenger seat or a camera) as well as other operations in the vehicle (e.g., turning headlights on, turn signals, gas and brake pedal, etc.). These latter characteristics may be detectable through a wearable device, as described above.

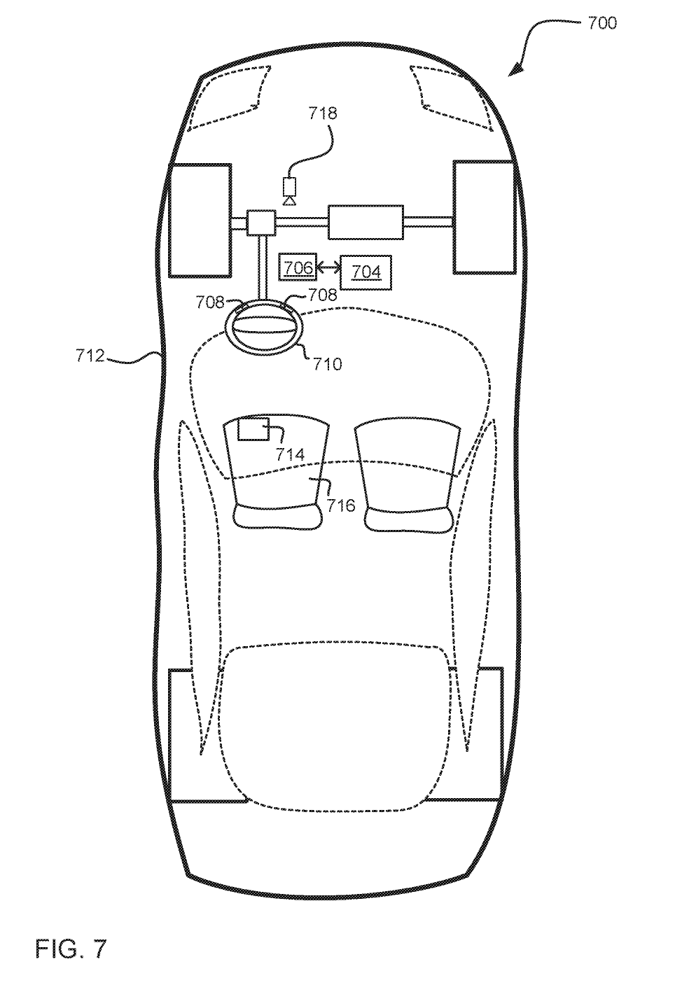

Referring to FIG. 7, an exemplary vehicle system 700 in accordance with an embodiment of the present disclosure is illustrated. The system 700 may include a mobile communication device 704 disposed in a vehicle 712 and configured for sending and receiving communication calls, and a transmission module 706 for receiving transmissions from a sensing device, for example, sensing device 302, 102, disposed on the user. In one embodiment, the mobile communication device 704 and the transmission module 706 are fixed or integral components of the vehicle 712 and may not be carried away when the vehicle is not in use. In this embodiment, a sensing device 302, 102 worn by the user communicates to the mobile communication device 704 via the transmission module 706 to provide an indication of a driving characteristic, as described above.

In other embodiments, a sensing device may be provided to be fixed to the vehicle, for example, a sensing device or sensor 708 configured to be disposed on a steering device 710 of the vehicle 712, sensing device or sensor 714 configured to be disposed on a driver's seat 716 of the vehicle 712, etc. The various sensing devices may confirm that a driver is present. In another embodiment, the sensors include an imaging device 718 to confirm that a driver is present. It is to be appreciated that sensing devices 708, 714, 718 may communicate to the transmission module 706 via hardwire means or wireless means. It is further to be appreciated that the various sensing devices integral to the vehicle, e.g., sensors 708, 714, 718, may communicate to a non-integral mobile communication device, for example, device 101, 201, 500.

In certain embodiments, the indication of the driving characteristic and the indication that a driver is present may both be required before altering operations of the mobile communication device 201, 101, 500, 600, 704.

Although an automobile is shown in FIG. 7, it is to be appreciated that the teachings of the present disclosure may be applied to any vehicle that is a mobile machine that transports people or cargo, e.g., wagons, bicycles, motor vehicles (such as motorcycles, cars, trucks, buses, etc.), railed vehicles (e.g., trains, trams, etc.), watercraft (e.g., ships, boats, etc.), aircraft and spacecraft. The determination of a user movement may be adapted to a particular vehicle. For example, an aircraft may require the pilot to pull or push the steering wheel (i.e., yoke, control wheel) up or down. For example, in a motorcycle or jet ski, the driver controls a handlebar, instead of a steering wheel. Pedals may also be used in an aircraft and in motorcycles. For example, in a boat, the control may be a lever and there may not be pedals. For example, in a ship, the control may be a 25 inch steering wheel.

It is to be understood that any of the methods of the present disclosure may be implemented in various forms of hardware, software, firmware, special purpose processors, or a combination thereof. The present disclosure may be implemented as a combination of hardware and software. Moreover, the software may be implemented as an application program tangibly embodied on a program storage device. The application program may be uploaded to, and executed by, a machine comprising any suitable architecture. The machine may implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

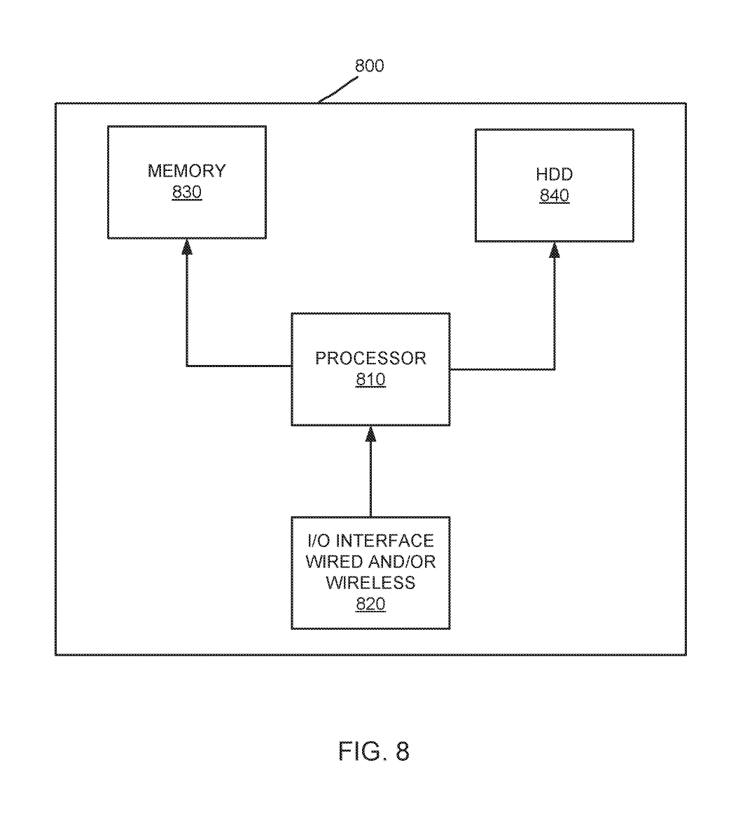

FIG. 8 illustrates a block diagram of an exemplary computing environment 800 within which any of the methods of the present disclosure may be implemented and executed. The computing environment 800 includes a processor 810, and at least one (and preferably more than one) I/O interface 820. The I/O interface 820 may be wired or wireless and, in the wireless implementation is pre-configured with the appropriate wireless communication protocols to allow the computing environment 800 to operate on a global network (e.g., internet) and communicate with other computers or servers (e.g., cloud based computing or storage servers) so as to enable the present disclosure to be provided, for example, as a Software as a Service (SAAS) feature remotely provided to end users. One or more memories 830 and/or storage devices (Hard Disk Drive (HDD)) 840 are also provided within the computing environment 800. The computing environment may be used to implement a node or device, and/or a controller or server that operates the storage system. The computing environment may be included in, but is not limited to, desktop computers, cellular phones, smart phones, phone watches, tablet computers, personal digital assistant (PDA), netbooks, laptop computers, set-top boxes or general multimedia content receiver and/or transmitter devices. The computer environment may be a part of any of the devices illustrated in FIG. 1, 2, 3, 5, 6 or 7, including devices, 101, 102, 201, 302, 500, 600 and 704, that is, including a sensing device and a mobile communication device.

Furthermore, aspects of the present disclosure may take the form of a computer-readable storage medium. Any combination of one or more computer-readable storage medium(s) may be utilized. A computer-readable storage medium may take the form of a computer-readable program product embodied in one or more computer-readable medium(s) and having computer-readable program code embodied thereon that is executable by a computer. A computer-readable storage medium as used herein is considered a non-transitory storage medium given the inherent capability to store the information therein as well as the inherent capability to provide retrieval of the information therefrom. A computer-readable storage medium may be, for example, but is not limited to, an electronic, magnetic, optical, electromagnetic, infrared, or semiconductor system, apparatus, or device, or any suitable combination of the foregoing.

It is to be appreciated that the following list, while providing more specific examples of computer-readable storage mediums to which the present disclosure may be applied, is merely an illustrative and not exhaustive listing as is readily appreciated by one of ordinary skill in the art. The list of examples includes a portable computer diskette, a hard disk, a read-only memory (ROM), an erasable programmable read-only memory (EPROM or Flash memory), a portable compact disc read-only memory (CD-ROM), an optical storage device, a magnetic storage device, or any suitable combination of the foregoing.

According to one aspect of the present disclosure, an apparatus for altering operation of a mobile communication device is provided, the apparatus including a processor in communication with at least one input/output interface, and at least one memory in communication with the processor, the processor being configured to perform any of the embodiments of the method of altering operation of a mobile communication device (in flowchart 400).

According to one aspect of the present disclosure, an apparatus for altering operation of a mobile communication device is provided, the apparatus including a processor in communication with at least one input/output interface for executing a set of instructions, and at least one memory in communication with the processor, said memory storing the set of instructions that when executed cause the processor to perform any of the embodiments of the method of altering operation of a mobile communication device (in flowchart 400).

According to one aspect of the present disclosure, a computer-readable storage medium carrying a software program is provided including program code instructions for performing any of the embodiments of the method of altering operation of a mobile communication device (in flowchart 400).

According to one aspect of the present disclosure, a non-transitory computer-readable program product is provided including program code instructions for performing any of the embodiments of the method of altering operation of a mobile communication device (in flowchart 400).

According to one aspect of the present disclosure, a second method of altering operation of a mobile communication device is provided including receiving an instruction to alter operation of a mobile communication device (101, 201, 500, 600, 704), the instruction generated according to any of the embodiments of the method of altering operation of a mobile communication device, and altering operation of the mobile communication device (101, 201, 500, 600, 704) according to the instruction.

According to one aspect of the present disclosure, an apparatus for altering operation of a mobile communication device is provided, the apparatus including a processor in communication with at least one input/output interface, and at least one memory in communication with the processor, the processor being configured to perform any of the embodiments of the second method of altering operation of a mobile communication device.

According to one aspect of the present disclosure, a computer-readable storage medium carrying a software program is provided including program code instructions for performing any of the embodiments of the second method of altering operation of a mobile communication device.

According to one aspect of the present disclosure, a non-transitory computer-readable program product is provided including program code instructions for performing any of the embodiments of the second method of altering operation of a mobile communication device.

It is to be appreciated that the various features shown and described are interchangeable, that is a feature shown in one embodiment may be incorporated into another embodiment. It is to be appreciated that more than one embodiment may be simultaneously implemented.

Although embodiments which incorporate the teachings of the present disclosure have been shown and described in detail herein, those skilled in the art may readily devise many other varied embodiments that still incorporate these teachings. Having described preferred embodiments of method and apparatus for altering a mobile communication device operation by a user while the user is operating or driving a vehicle (which are intended to be illustrative and not limiting), it is noted that modifications and variations may be made by persons skilled in the art in light of the above teachings. It is therefore to be understood that changes may be made in the particular embodiments of the disclosure disclosed which are within the scope of the disclosure as outlined by the appended claims.

1. A method (400) of altering operation of a mobile communication device comprising:
receiving data from a sensor, said data related to movement performed by a user;
determining if said user is driving a vehicle by determining at least one user movement associated with driving a vehicle based on said data; and
altering operation of said mobile communication device if it is determined that said user is driving said vehicle.

2. The method of claim 1 wherein said at least one user movement is turning a steering wheel.

3-6. (canceled)

7. The method of claim 1 wherein said data includes a user position and said determining further comprises:
determining a velocity of said user relative to the ground based on said data; and
determining if said user is driving said vehicle is further based on said velocity.

8. The method of claim 1 wherein the method is performed by a sensing device comprising said sensor.

9. (canceled)

10. The method of claim 1 wherein said sensor and said mobile communication device are disposed in a single device.

11-12. (canceled)

13. The method of claim 1 wherein said altering further comprises:
disabling at least one functionality of said mobile communication device.

14-15. (canceled)

16. The method of claim 13 wherein said altering further comprises:
maintaining at least one functionality necessary for emergency operation of said mobile communication device.

17. The method of claim 13 further comprising:
reinstating said at least one functionality of said mobile communication device if it is determined that said at least one user movement has not been performed by said user for a predetermined period of time.

18. The method of claim 1 wherein said altering further comprises:
generating a flag or instruction to alter operation of said mobile communication device.

19. The method of claim 1 wherein said altering further comprises:
sending a flag or instruction to alter operation of said mobile communication device.

20. The method of claim 1 wherein said altering further comprises:
executing said a flag or instruction to alter operation of said mobile communication device.

21. An apparatus for altering operation of a mobile communication device, said apparatus comprising:
a processor in communication with at least one input/output interface; and at least one memory in communication with said processor, said processor being configured to:
receive data from a sensor, said data related to movement performed by a user;
determine if said user is driving a vehicle by determining at least one user movement associated with driving a vehicle based on said data; and
alter operation of said mobile communication device if it is determined that said user is driving said vehicle.

22. The apparatus of claim 21 wherein said at least one user movement is turning a steering wheel.

23-26. (canceled)

27. The apparatus of claim 21 wherein said data includes a user position and said processor is configured to determine by being further configured to:
determine a velocity of said user relative to the ground based on said data; and determine if said user is driving said vehicle is further based on said velocity.

28. The apparatus of claim 21 wherein said apparatus comprises a sensing device including said sensor.

29. (canceled)

30. The apparatus of claim 21 wherein said apparatus comprises said sensor and said mobile communication device in a single device.

31-32. (canceled)

33. The apparatus of claim 21 wherein said processor is configured to alter by being further configured to:
disable at least one functionality of said mobile communication device.

34-35. (canceled)

36. The apparatus of claim 33 wherein said processor is configured to alter by being further configured to:
maintain at least one functionality necessary for emergency operation of said mobile communication device.

37. The apparatus of claim 33 wherein said processor is configured to alter by being further configured to:
reinstate said at least one functionality of said mobile communication device if it is determined that said at least one user movement has not been performed by said user for a predetermined period of time.

38. The apparatus of claim 21 wherein said processor is configured to alter by being further configured to:
generate a flag or instruction to alter operation of said mobile communication device.

39. The apparatus of claim 38 wherein said processor is configured to alter by being further configured to:
send a flag or instruction to alter operation of said mobile communication device.

40. The apparatus of claim 38 wherein said flag or instruction to alter operation of said mobile communication device is executed by said mobile communication device.
